(19) United States
(12) Patent Application Publication
(10) Pub. No.: US 2018/0039808 A1
(43) Pub. Date: Feb. 8, 2018

(54) FINGERPRINT IDENTIFICATION MODULE AND FINGERPRINT IDENTIFICATION METHOD

(71) Applicant: Gingy Technology Inc., Hsinchu City (TW)

(72) Inventor: Yuan-Yu Lo, Hsinchu City (TW)

(73) Assignee: Gingy Technology Inc., Hsinchu City (TW)

(21) Appl. No.: 15/402,248

(22) Filed: Jan. 10, 2017

Related U.S. Application Data
(60) Provisional application No. 62/371,230, filed on Aug. 5, 2016.

(30) Foreign Application Priority Data
Oct. 17, 2016 (TW) 105133459

(51) Int. Cl. G06K 9/00; G06F 1/32

(52) U.S. Cl. CPC G06K 9/0002; G06K 9/0004; G06F 1/3231; G06K 9/00087; G06K 9/00067

(57) ABSTRACT

A fingerprint identification module including a fingerprint feature extraction device, a first processor and a power controller is provided. The fingerprint feature extraction device is configured to extract a fingerprint feature data. The first processor is coupled to the fingerprint feature extraction device. The first processor is configured to receive the fingerprint feature data. The power controller is coupled to the first processor and a power source system of an electrical device. The first processor verifies the fingerprint feature data based on a first fingerprint feature database, and determines whether to output a confirm signal to the power controller according to a verification result of the fingerprint feature data, such that the power controller activates the power source system according to the confirm signal, where the electrical device has a biometric framework. In addition, a fingerprint identification method is also provided.

### CROSS-REFERENCE TO RELATED APPLICATION

This application claims the priority benefits of U.S. provisional application Ser. No. 62/371,230, filed on Aug. 5, 2016, and Taiwan application serial no. 105133459, filed on Oct. 17, 2016. The entirety of each of the above-mentioned patent applications is hereby incorporated by reference herein and made a part of this specification.

### BACKGROUND OF THE INVENTION

### Field of the Invention

The invention relates to a fingerprint identification technique, and particularly relates to a fingerprint identification module and a fingerprint identification method.

### Description of Related Art

Along with progress of biometric identification technology, related applications of the biometric identification technology have become increasingly popular in people's daily life. Particularly, it is an important issue to apply the biometric identification technology to protect user data of personal computer devices. However, a conventional power-on verification mechanism of the personal computer device is mainly to execute a verification program installed in a basic input/output system (BIOS) and a master boot record (MBR) to implement user identity verification. Therefore, the user has to wait for power-on of the personal computer device, and perform the user identity verification through a verification framework or a verification program provided by a manufacturer of the personal computer device. Only when the verification is successful, the personal computer device may log in an operating system. Namely, since the BIOS and MBR have to be adopted to implement the conventional power-on verification mechanism, the user has to go through a complicated verification procedure before using the personal computer device, and the personal computer device consumes more power to execute a login operation of the operating system. Therefore, the invention provides a plurality of solutions of several embodiments below.

### SUMMARY OF THE INVENTION

The invention is directed to a fingerprint identification module and a fingerprint identification method, where the fingerprint identification module embedded in an electronic device is used to verify a fingerprint feature data of a user, such that the user is adapted to automatically activate a power system of the electronic device through the fingerprint identification module.

The invention provides a fingerprint identification module including a fingerprint feature extraction device, a first processor and a power controller. The fingerprint feature extraction device is configured to extract a fingerprint feature data. The first processor is coupled to the fingerprint feature extraction device. The first processor is configured to receive the fingerprint feature data. The power controller is coupled to the first processor and a power system of an electrical device. The electronic device has a biometric framework. The first processor verifies the fingerprint feature data based on a first fingerprint feature database, and determines whether to output a confirm signal to the power controller according to a verification result of the fingerprint feature data, such that the power controller activates the power system according to the confirm signal.

In an embodiment of the invention, the first processor further determines whether to output the fingerprint feature data to the electronic device according to the verification result of the fingerprint feature data.

In an embodiment of the invention, the electronic device further includes a second processor. The second processor is coupled to the first processor. The second processor is configured to receive the fingerprint feature data. After the power controller activates the power system of the electronic device, the second processor enables the biometric framework, and verifies the fingerprint feature data through the biometric framework, so as to determine whether to log in an operating system.

In an embodiment of the invention, the biometric framework includes identifying the fingerprint feature data according to at least one of the first fingerprint feature database and a second fingerprint feature database.

In an embodiment of the invention, the fingerprint feature extraction device includes a fingerprint sensor and a touch controller. The fingerprint sensor is configured to sense whether a finger touch event is occurred. The touch controller is coupled to the fingerprint sensor. The touch controller is configured to generate a sensing signal according to the finger touch event. The touch controller provides the sensing signal to the power controller through the first processor, and the power controller transmits back a start signal to the touch controller according to the sensing signal. The touch controller operates the fingerprint sensor to extract the fingerprint feature data according to the start signal.

In an embodiment of the invention, the fingerprint identification module is embedded in the electronic device, and the power controller is an embedded controller.

In an embodiment of the invention, the biometric framework is a Windows biometric framework.

In an embodiment of the invention, the electronic device is a portable personal computer.

The invention provides a fingerprint identification method adapted to a fingerprint identification module. The fingerprint identification module includes a fingerprint feature extraction device, a first processor and a power controller. The fingerprint identification method includes: extracting a fingerprint feature data by using the fingerprint feature extraction device; verifying the fingerprint feature data based on a first fingerprint feature database by using the first processor; and determining whether to generate a confirm signal to the power controller according to a verification result of the fingerprint feature data by using the first processor, such that the power controller activates a power system of an electronic device according to the confirm signal, wherein the electronic device has a biometric framework.

In an embodiment of the invention, the step of determining whether to generate the confirm signal to the power controller according to the verification result of the fingerprint feature data, such that the power controller activates the electronic device according to the confirm signal includes determining whether to output the fingerprint feature data to the electronic device according to the verification result of the fingerprint feature data.

In an embodiment of the invention, when the power controller activates the power system, a second processor of the electronic device enables the biometric framework, and verifies the fingerprint feature data through the biometric framework, so as to determine whether to log in an operating system.

In an embodiment of the invention, the biometric framework includes identifying the fingerprint feature data according to at least one of the first fingerprint feature database and a second fingerprint feature database.

In an embodiment of the invention, the fingerprint feature extraction device includes a fingerprint sensor and a touch controller. The step of extracting the fingerprint feature data by using the fingerprint feature extraction device includes sensing whether a finger touch event is occurred by using the fingerprint sensor; generating a sensing signal according to the finger touch event by using the touch controller; providing the sensing signal to the power controller, such that the power controller transmits back a start signal to the touch controller according to the sensing signal; and extracting the fingerprint feature data by using the fingerprint sensor.

In an embodiment of the invention, the fingerprint identification module is embedded in the electronic device, and the power controller is an embedded controller.

In an embodiment of the invention, the biometric framework is a Windows biometric framework.

In an embodiment of the invention, the electronic device is a portable personal computer.

According to the above description, based on the fingerprint identification module and the fingerprint identification method of the invention, user's identity can be verified through the fingerprint identification module configured in the electronic device. Moreover, only when the verification is passed, the fingerprint identification module activates the power system of the electronic device. Therefore, the fingerprint identification module and the fingerprint identification method of the invention may effectively decrease power consumption of the electronic device, and effectively protect data of the electronic device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a fingerprint identification module according to an embodiment of the invention.

FIG. 2 is a schematic diagram of a fingerprint identification module according to another embodiment of the invention.

FIG. 3 is a flowchart illustrating a first phase fingerprint identification operation according to an embodiment of the invention.

FIG. 4 is a flowchart illustrating a second phase fingerprint identification operation according to an embodiment of the invention.

FIG. 5 is a schematic diagram of a biometric framework according to an embodiment of the invention.

FIG. 6 is a flowchart illustrating a fingerprint identification method according to an embodiment of the invention.

### DESCRIPTION OF EMBODIMENTS

A term “couple” used in the full text of the disclosure (including the claims) refers to any direct and indirect connections. For example, if a first device is described to be coupled to a second device, it is interpreted as that the first device is directly coupled to the second device, or the first device is indirectly coupled to the second device through other devices or connection means. Moreover, wherever possible, components/members/steps using the same referential numbers in the drawings and description refer to the same or like parts. Components/members/steps using the same referential numbers or using the same terms in different embodiments may cross-refer related descriptions.

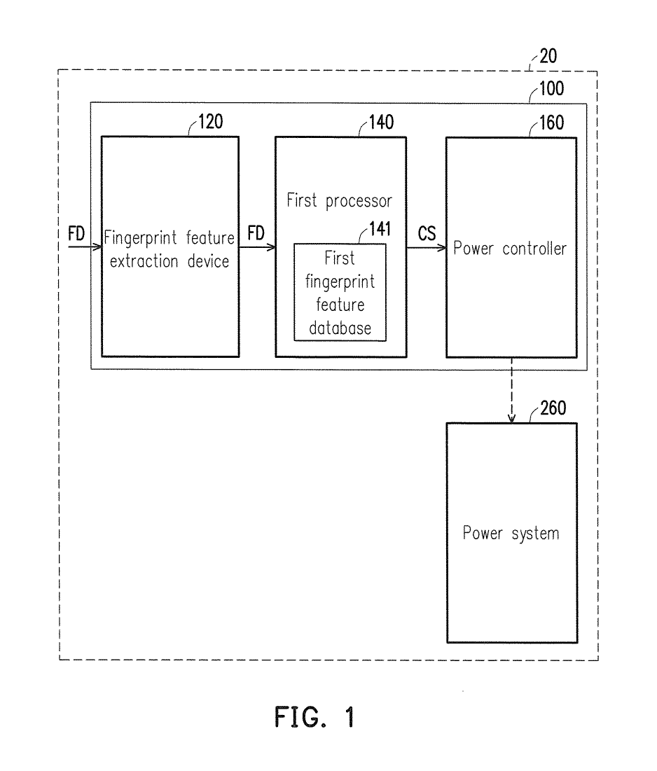

FIG. 1 is a schematic diagram of a fingerprint identification module according to an embodiment of the invention. Referring to FIG. 1, the fingerprint identification module 100 includes a fingerprint feature extraction device 120, a first processor 140 and a power controller 160. The first processor 140 is coupled to the fingerprint feature extraction device 120. The power controller 160 is coupled to the first processor 140 and a power system 260 of an electronic device 20. In the present embodiment, the fingerprint feature extraction device 120 is configured to extract a fingerprint feature data FD of a user. After the fingerprint feature extraction device 120 extracts the fingerprint feature data FD, the fingerprint feature extraction device 120 transmits the fingerprint feature data FD to the first processor 140, and the first processor 140 verifies the fingerprint feature data FD based on a first fingerprint feature database 141.

In the present embodiment, when the user wants to use the electronic device 20, the fingerprint feature extraction device 120 may extract the fingerprint feature data FD of the user, and provides the fingerprint feature data FD to the first processor 140. In the present embodiment, the first processor 140 may compare the fingerprint feature data FD with fingerprint data stored in the first fingerprint feature database 141, so as to verify a fingerprint provided by the user. To be specific, if a verification result is valid, the first processor 140 may output a confirm signal CS to the power controller 160, and the power controller 160 activates the power system 260 according to the confirm signal CS. If the verification result is invalid, the first processor 140 does not output the confirm signal CS to the power controller 160. Namely, the fingerprint identification module 100 of the present embodiment can be used for verifying an identity of the user, and determining whether to activate the power of the electronic device 20 according to the verification result. Moreover, the electronic device 20 may have a biometric framework.

In the present embodiment, the fingerprint identification module 100 can be an embedded module, and the power controller 160 can be an embedded controller. Namely, the fingerprint identification module 100 of the present embodiment can be integrated in the electronic device 20. The fingerprint identification module 100 is configured to provide a fingerprint identification function, and the power controller 160 may execute a power-on operation of the electronic device 20. Moreover, in the present embodiment, the electronic device 20 can be a portable personal computer, for example, a laptop computer or a notebook computer, etc., though the invention is not limited thereto. In an embodiment, the electronic device 20 can also be a desktop computer, or a tablet PC, etc., which is not limited by the invention.

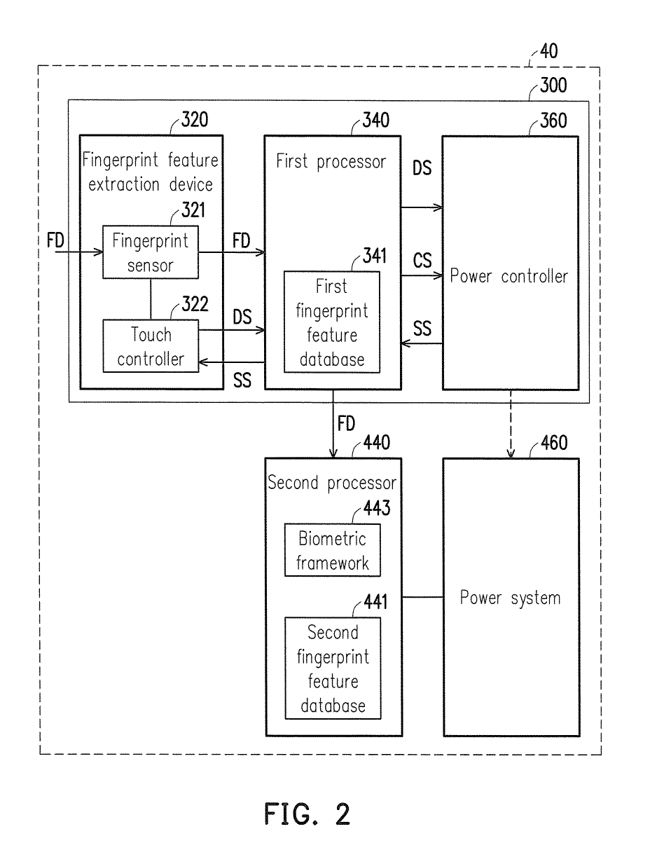

FIG. 2 is a schematic diagram of a fingerprint identification module according to another embodiment of the invention. Referring to FIG. 2, the fingerprint identification module 300 includes a fingerprint feature extraction device 320, a first processor 340 and a power controller 360. The first processor 340 is coupled to the fingerprint feature extraction device 320. The power controller 360 is coupled to the first processor 340 and a power system of an electronic device 40. In the present embodiment, the electronic device 40 is installed with the biometric framework, and the fingerprint identification module 300 supports the biometric framework of the electronic device 40. However, the biometric framework of the present embodiment is, for example, a Windows biometric framework (WBF), though the invention is not limited thereto. In an embodiment, the electronic device 40 may also install a biometric framework constructed based on other operating system.

In the present embodiment, the fingerprint feature extraction device 320 may include a fingerprint sensor 321 and a touch controller 322. The fingerprint sensor 321 is configured to sense whether a finger touch event is occurred, and the touch controller 322 generates a sensing signal DS according to the finger touch event, and the touch controller 322 provides the sensing signal DS to the power controller 360 through the first processor 340. In the present embodiment, the power controller 360 may transmit back a start signal SS to the touch controller 322 according to the sensing signal DS, and the touch controller 322 operates the fingerprint sensor 321 to extract the fingerprint feature data FD of the finger touch event, and provide the fingerprint feature data FD to the first processor 340.

In the present embodiment, the fingerprint touch event refers to that the user's finger presses or touches the fingerprint sensor 321 of the fingerprint feature extraction device 320, and the fingerprint sensor 321 may extract a fingerprint mage through a capacitive or an optical manner, and may obtain the fingerprint feature data FD through calculation. However, instructions and recommendations for a detail technical means and calculation method through which the fingerprint sensor 321 obtains the fingerprint feature data FD can be learned through ordinary knowledge of the field, which are not repeated.

In the present embodiment, the first processor 340 is coupled to a second processor 440 of the electronic device 40. The power controller 360 is coupled to a power system 460 of the electronic device 40. In the present embodiment, when the fingerprint feature data FD passes through the verification of the first processor 340, the first processor 340 outputs the confirm signal CS to the power controller 360, and the power controller 360 activates the power system 460 of the electronic device 40. Then, after the power controller 360 activates the power system 460, the second processor 440 of the electronic device 40 may enable the biometric framework. Moreover, the second processor 440 receives the fingerprint feature data FD verified by the first processor 340, and again verifies the fingerprint feature data FD through the biometric framework, so as to determine whether to log in an operating system (OS) installed in the electronic device 40.

In the present embodiment, the first processor 340 verifies the fingerprint feature data FD based on a first fingerprint feature database 341. The first processor 340 may determine whether the fingerprint feature data FD is complied with user fingerprint data pre-stored in the first fingerprint feature database 341. The second processor 440 may verify the fingerprint feature data FD according to at least one of the first fingerprint feature database 341 and a second fingerprint feature database 441. The second processor 440 may determine whether the fingerprint feature data FD is complied with user fingerprint data pre-stored in at least one of the first fingerprint feature database 341 and the second fingerprint feature database 441. In the present embodiment, the first processor 340 and the second processor 440 may perform the fingerprint verification by executing a same or different fingerprint feature algorithms, which is not limited by the invention.

In the present embodiment, the first processor 340 and the second processor 440 are, for example, central processing units (CPU), programmable general purpose or special purpose microprocessors, digital signal processors (DSP), programmable controllers, application specific integrated circuits (ASIC), programmable logic devices (PLD) or any other similar devices or a combination thereof. Moreover, the first processor 340 and the second processor 440 may respectively use a cache memory to store the first fingerprint feature database 341 and the second fingerprint feature database 441. Alternatively, the first processor 340 and the second processor 440 may also be respectively coupled to a memory device. The first processor 340 and the second processor 440 may read the first fingerprint feature database 341 and the second fingerprint feature database 441 stored in the memory device to perform the fingerprint verification.

In the present embodiment, since the fingerprint identification module 300 is embedded in the electronic device 40, and the electronic device 40 is installed with the biometric framework, the electronic device 40 may include two phases of fingerprint identification operations. For example, the two phases of fingerprint identification operations include a first phase and a second phase fingerprint identification operations. In the present embodiment, the first phase fingerprint identification operation can be executed by the first processor 340, and the second phase fingerprint identification operation can be executed by the second processor 440. The user may perform a power-on operation to the electronic device 40 through the fingerprint identification module 300, and then the fingerprint of the user is verified through the biometric framework of the electronic device 40, so as to log in the operating system of the electronic device 40. In this way, as long as the fingerprint feature data FD is extracted through the fingerprint identification module 300, the user may perform a power-on verification operation and a login verification operation.

Moreover, in the present embodiment, the user may register the fingerprint data through the biometric framework, so as to pre-store the same into the first fingerprint feature database 341 and the second fingerprint feature database 441. For example, when the finger of the user presses the fingerprint sensor 321, first, the fingerprint sensor 321 may extract a plurality of fingerprint images of one fingerprint of the user, and provide the fingerprint images to the biometric framework to synthesize integral fingerprint data of the fingerprint. Then, the first processor 340 and the second processor 440 may store the integral fingerprint data of the fingerprint to the first fingerprint feature database 341 and the second fingerprint feature database 441. Namely, after the user registers the fingerprint data, the first fingerprint feature database 341 and the second fingerprint feature database 441 may simultaneously store the same fingerprint data.

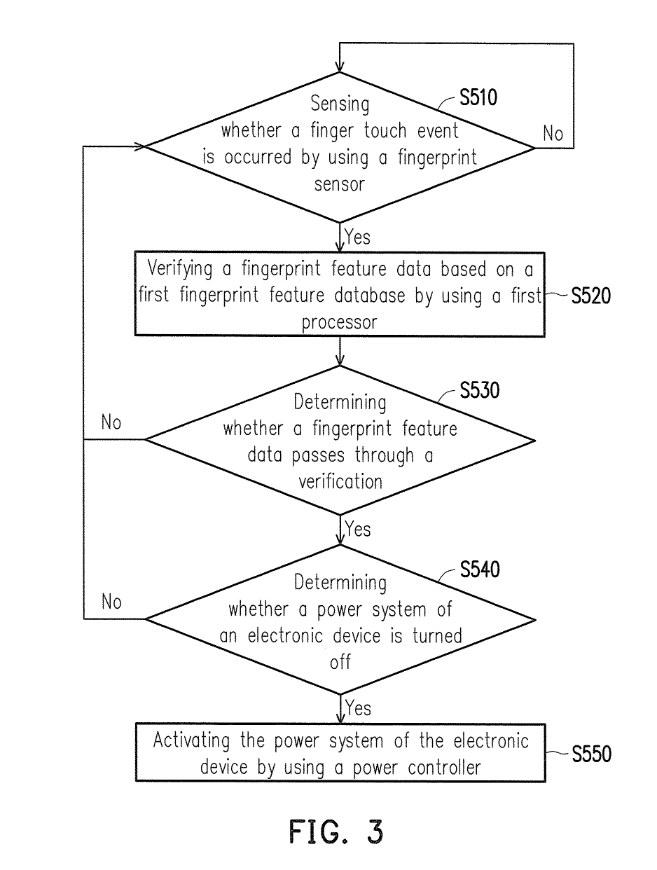

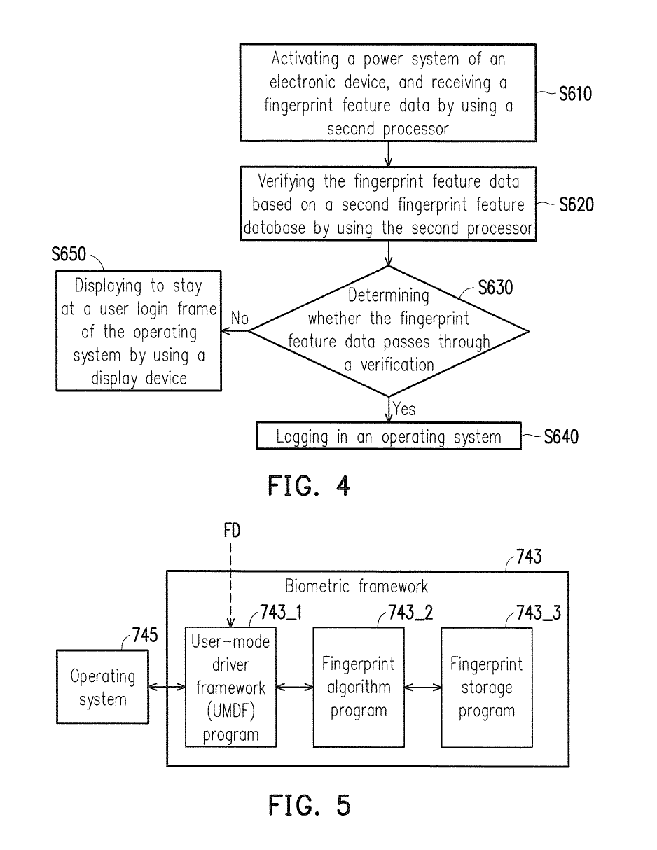

The first phase fingerprint identification operation and the second phase fingerprint identification operation of the embodiment of FIG. 2 are described in detail below with reference of flowcharts of FIG. 3 and FIG. 4.

FIG. 3 is a flowchart illustrating a first phase fingerprint identification operation according to an embodiment of the invention. Referring to FIG. 2 and FIG. 3, the fingerprint identification operation of the present embodiment is at least adapted to the fingerprint identification module 300 of FIG. 2. In step S510, the fingerprint identification module 300 senses whether a finger touch event is occurred by using the fingerprint sensor 321. If not, the fingerprint identification module 300 re-executes the step S510. If yes, in step S520, the fingerprint identification module 300 verifies the fingerprint feature data FD based on the first fingerprint feature database 341 by using the first processor 340. In step S530, the fingerprint identification module 300 determines whether the fingerprint feature data FD passes through the verification. If not, the fingerprint identification module 300 re-executes the step S510. If yes, in step S540, the fingerprint identification module 300 determines whether the power system 460 of the electronic device 40 is turned off. If not, the fingerprint identification module 300 re-executes the step S510. If yes, in step S550, the fingerprint identification module 300 activates the power system 460 of the electronic device 40 by using the power controller 360. Namely, if the user passes through the first phase fingerprint identification operation, the fingerprint identification module 300 may activate the power system 460 of the electronic device 40 through the power controller 360. However, if the user does not pass through the first phase fingerprint identification operation, the fingerprint identification module 300 does not activate the power system 460 of the electronic device 40. In this way, the fingerprint identification module 300 of the present embodiment may effectively decrease an energy consumption of the electronic device 40.

FIG. 4 is a flowchart illustrating a second phase fingerprint identification operation according to an embodiment of the invention. Referring to FIG. 2 and FIG. 4, the fingerprint identification operation of the present embodiment is at least adapted to the fingerprint identification module 300 of FIG. 2. In step S610, when the power controller 360 activates the power system 460 of the electronic device 40, the second processor 440 of the electronic device 40 may receive the fingerprint feature data FD verified by the first processor 340. In step S620, the electronic device 40 may verify the fingerprint feature data FD based on the second fingerprint feature database 441 through a biometric framework 443 by using the second processor 440. In step S630, the second processor 440 determines whether the fingerprint feature data FD passes through the verification. If yes, in step S640, the second processor 440 may directly log in the operating system of the electronic device 40. If not, in step S650, the operating system of the electronic device 40 displays to stay at a user login frame of the operating system by using a display device. Namely, when the user passes through the second phase fingerprint identification operation, the user may log in the operating system of the electronic device 40. Moreover, the user may execute the power-on verification operation and the login verification operation by only providing the fingerprint feature data in the first phase fingerprint identification operation of the embodiment of FIG. 3. In this way, the fingerprint identification module 300 of the present embodiment may effectively decrease the power consumption of the electronic device 40, and effectively protect data in the protection device 40. Moreover, it should be noted that in the step S620, the biometric framework 443 is not limited to verify the fingerprint feature data FD based on the second fingerprint feature database 441. In an embodiment, the biometric framework 443 may also compare the fingerprint feature data FD based on the fingerprint data pre-stored in the first fingerprint feature database 341, or may compare the fingerprint feature data FD simultaneously based on the first fingerprint feature database 341 and the second fingerprint feature database 441.

FIG. 5 is a schematic diagram of a biometric framework according to an embodiment of the invention. Referring to FIG. 5, the electronic device in each embodiment of the invention can be installed with a biometric framework 743. The biometric framework 743 refers to that the electronic device can be installed with a user-mode driver framework (UMDF) program, a fingerprint algorithm program and a fingerprint storage program, such that the second processor may implement fingerprint feature identification by executing the biometric framework 743. To be specific, after the fingerprint feature data FD passes through the verification of the first processor of each of the aforementioned exemplary embodiments, the UMDF program 743_1 extracts the fingerprint feature data FD, and provides the same to the fingerprint algorithm program 743_2. Then, the fingerprint algorithm program 743_2 obtains corresponding fingerprint feature data based on the first fingerprint feature database of the first processor of each of the aforementioned exemplary embodiments, and compares the same with the fingerprint data in the fingerprint storage program 743_3, where the fingerprint storage program 743_3 may read at least one of the first fingerprint feature database and the second fingerprint feature database of each of the aforementioned exemplary embodiments. If passing the verification, the UMDF program 743_1 may directly log in an operating system 745.

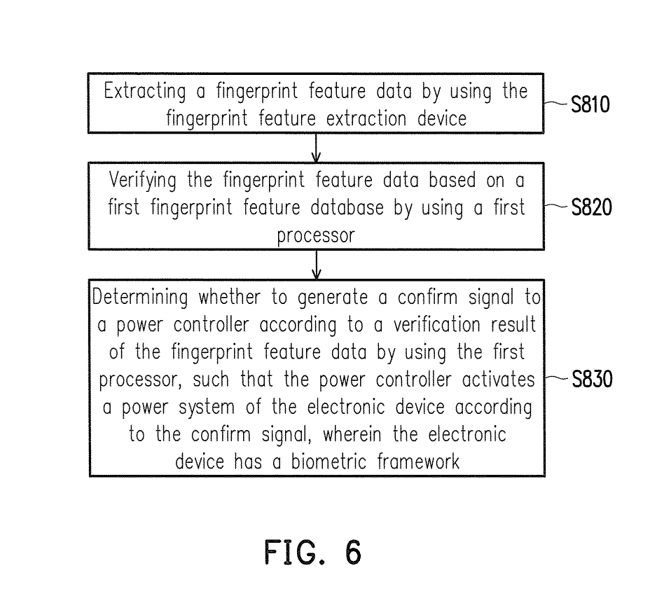

FIG. 6 is a flowchart illustrating a fingerprint identification method according to an embodiment of the invention. Referring to FIG. 1 and FIG. 6, the fingerprint identification method of the present embodiment is adapted to the electronic device 20 and the fingerprint identification module 100 of FIG. 1. The electronic device 20 includes the power system 260, and the fingerprint identification module 100 includes the fingerprint feature extraction device 120, the first processor 140 and the power controller 160. In step S810, the fingerprint identification module 100 extracts the fingerprint feature data FD by using the fingerprint feature extraction device 120. In step S820, the fingerprint identification module 100 verifies the fingerprint feature data FD based on the first fingerprint feature database 141 by using the first processor 140. In step S830, the first processor 140 determines whether to generate the confirm signal CS to the power controller 160 according to a verification result of the fingerprint feature data FD, such that the power controller 160 activates the power system 260 of the electronic device 20 according to the confirm signal CS, wherein the electronic device 20 has a biometric framework. Namely, before the power of the electronic device 20 is power-on, the fingerprint identification module 100 may provide a fingerprint verification function in advance. In this way, the fingerprint identification method of the present embodiment may effectively save the power consumption of the electronic device 20, and has a function of protecting the data of the electronic device 20.

Moreover, since those skilled in the art can learn enough instructions and recommendations for the fingerprint identification method of the present embodiment from the descriptions of the embodiments of FIG. 1 to FIG. 5, detailed description thereof is not repeated.

In summary, according to the fingerprint identification module and the fingerprint identification method of the exemplary embodiments of the invention, the fingerprint identification module can be embedded into the electronic device to control the power system of the electronic device. Only when the fingerprint feature data of the user passes through the verification of the fingerprint identification module, the fingerprint identification module activates the power system of the electronic device. Then, the fingerprint identification module provides the verified fingerprint feature data to the electronic device, and the electronic device again verifies the fingerprint feature data through the biometric framework installed in the electronic device. Namely, the fingerprint identification module and the fingerprint identification method of the exemplary embodiment of the invention may have two phases of the fingerprint identification function. Moreover, if the fingerprint identification module and the electronic device are registered with the same fingerprint data, as long as the user provides the fingerprint feature data to the fingerprint identification module, the fingerprint identification module may execute the power-on operation of the electronic device, and the electronic device automatically executes the login operation of the operating system.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A fingerprint identification module, comprising:
a fingerprint feature extraction device, configured to extract a fingerprint feature data;
a first processor, coupled to the fingerprint feature extraction device, and configured to receive the fingerprint feature data; and
a power controller, coupled to the first processor and a power system of an electrical device, wherein the electronic device has a biometric framework,
wherein the first processor verifies the fingerprint feature data based on a first fingerprint feature database, and determines whether to output a confirm signal to the power controller according to a verification result of the fingerprint feature data, such that the power controller activates the power system according to the confirm signal.

2. The fingerprint identification module as claimed in claim 1, wherein the first processor further determines whether to output the fingerprint feature data to the electronic device according to the verification result of the fingerprint feature data.

3. The fingerprint identification module as claimed in claim 1, wherein the electronic device further comprises:
a second processor, coupled to the first processor, and configured to receive the fingerprint feature data,
wherein after the power controller activates the power system of the electronic device, the second processor enables the biometric framework, and verifies the fingerprint feature data through the biometric framework, so as to determine whether to log in an operating system.

4. The fingerprint identification module as claimed in claim 3, wherein the biometric framework comprises identifying the fingerprint feature data according to at least one of the first fingerprint feature database and a second fingerprint feature database.

5. The fingerprint identification module as claimed in claim 1, wherein the fingerprint feature extraction device comprises:
a fingerprint sensor, configured to sense whether a finger touch event is occurred; and
a touch controller, coupled to the fingerprint sensor, and configured to generate a sensing signal according to the finger touch event,
wherein the touch controller provides the sensing signal to the power controller through the first processor, and the power controller transmits back a start signal to the touch controller according to the sensing signal, and the touch controller operates the fingerprint sensor to extract the fingerprint feature data according to the start signal.

6. The fingerprint identification module as claimed in claim 1, wherein the fingerprint identification module is embedded in the electronic device, and the power controller is an embedded controller.

7. The fingerprint identification module as claimed in claim 1, wherein the biometric framework is a Windows biometric framework.

8. The fingerprint identification module as claimed in claim 1, wherein the electronic device is a portable personal computer.

9. A fingerprint identification method, adapted to a fingerprint identification module, wherein the fingerprint identification module comprises a fingerprint feature extraction device, a first processor and a power controller, the fingerprint identification method comprising:
extracting a fingerprint feature data by using the fingerprint feature extraction device;
verifying the fingerprint feature data based on a first fingerprint feature database by using the first processor; and
determining whether to generate a confirm signal to the power controller according to a verification result of the fingerprint feature data by using the first processor, such that the power controller activates a power system of an electronic device according to the confirm signal, wherein the electronic device has a biometric framework.

10. The fingerprint identification method as claimed in claim 9, wherein the step of determining whether to generate the confirm signal to the power controller according to the verification result of the fingerprint feature data, such that the power controller activates the electronic device according to the confirm signal comprises:
determining whether to output the fingerprint feature data to the electronic device according to the verification result of the fingerprint feature data.

11. The fingerprint identification method as claimed in claim 9, wherein when the power controller activates the power system, a second processor of the electronic device enables the biometric framework, and verifies the fingerprint feature data through the biometric framework, so as to determine whether to log in an operating system.

12. The fingerprint identification method as claimed in claim 11, wherein the biometric framework comprises identifying the fingerprint feature data according to at least one of the first fingerprint feature database and a second fingerprint feature database.

13. The fingerprint identification method as claimed in claim 9, wherein the fingerprint feature extraction device comprises a fingerprint sensor and a touch controller, wherein the step of extracting the fingerprint feature data by using the fingerprint feature extraction device comprises:
sensing whether a finger touch event is occurred by using the fingerprint sensor;
generating a sensing signal according to the finger touch event by using the touch controller;
providing the sensing signal to the power controller, such that the power controller transmits back a start signal to the touch controller according to the sensing signal; and
extracting the fingerprint feature data by using the fingerprint sensor.

14. The fingerprint identification method as claimed in claim 9, wherein the fingerprint identification module is embedded in the electronic device, and the power controller is an embedded controller.

15. The fingerprint identification method as claimed in claim 9, wherein the biometric framework is a Windows biometric framework.

16. The fingerprint identification method as claimed in claim 9, wherein the electronic device is a portable personal computer.
